(19) United States
(12) Patent Application Publication
(10) Pub. No.: US 2026/0270865 A1
(43) Pub. Date: Sep. 10, 2026

(54) Access Point Mode Switching in Dynamic Power Save Operation

(71) Applicant: Apple Inc., Cupertino, CA (US)

(72) Inventors: Yong Ho Seok, Cupertino, CA (US); Abdel Karim Ajami, San Jose, CA (US); Ahmad Reza Hedayat, Carlsbad, CA (US); Anuj Batra, Redwood City, CA (US); Chittabrata Ghosh, San Jose, CA (US); Jarkko L. Kneckt, Los Gatos, CA (US); Morteza Mehrnoush, Hayward, CA (US); Neelakantan Nurani Krishnan, San Diego, CA (US); Su Khiong Yong, Palo Alto, CA (US); Yan Zhang, Palo Alto, CA (US); Yong Liu, Campbell, CA (US)

(21) Appl. No.: 19/556,948

(22) Filed: Mar. 4, 2026

Related U.S. Application Data
(60) Provisional application No. 63/766,915, filed on Mar. 4, 2025.

(51) Int. Cl. H04W 52/02

(52) U.S. Cl. CPC H04W 52/0206

(57) ABSTRACT

This disclosure relates to methods for access point mode switching during dynamic power save (DPS) mode operation in a wireless local area network system. A wireless device can operate in a lower capability mode of DPS operation and buffer data intended for a wireless station. Further, the wireless device can transition to a higher capability mode of DPS operation to participate in a transmit opportunity and transmit, during the transmit opportunity, the data to the wireless station. In addition, the wireless device can defer channel access for at least a first period of time upon completion of the transmit opportunity.

### PRIORITY DATA

This application claims benefit of priority to U.S. Provisional Application Ser. No. 63/766,915, titled “Access Point Mode Switching in Dynamic Power Save Operation”, filed Mar. 4, 2025, which is hereby incorporated by reference in its entirety as though fully and completely set forth herein.

### TECHNICAL FIELD

The present application relates to wireless communication, including techniques and devices for access point mode switching during dynamic power save mode operation in a wireless local area network system, e.g., such as an IEEE 802.11 based system.

### DESCRIPTION OF THE RELATED ART

Wireless communication systems are ubiquitous. Further, wireless communication technology has evolved from voice-only communications to also include the transmission of data, such as Internet and multimedia content.

Mobile electronic devices, or stations (STAs) or user equipment devices (UEs), can take the form of smart phones or tablets that a user typically carries. One aspect of wireless communication that can commonly be performed by mobile devices can include wireless networking, for example over a wireless local area network (WLAN), which can include devices that operate according to one or more communication standards in the IEEE 802.11 family of standards. In a wireless local area network, it can be possible that certain traffic can be delayed while other communications in the network are being performed. This can potentially cause performance degradation for traffic for which low latency is important, at least in some instances. Accordingly, improvements in the field are desired.

### SUMMARY

Embodiments are presented herein of, inter alia, systems, apparatuses, and methods for access point mode switching during dynamic power save (DPS) mode operation in a wireless local area network system, e.g., such as an IEEE 802.11 based system.

A wireless device can include one or more antennas, one or more radios operably coupled to the one or more antennas, and a processor operably coupled to the one or more radios. The wireless device can be configured to establish a connection with an access point through a wireless local area network (WLAN) over one or multiple wireless links or can be an access point, e.g., a mobile access point, configured to establish a connection with one or more other wireless devices through a WLAN over one or multiple wireless links. In some embodiments, the wireless device can operate in each of the multiple wireless links using a respective radio of the one or more radios.

Similarly, an access point, e.g., a mobile access point, can include one or more antennas, one or more radios operably coupled to the one or more antennas, and a processor operably coupled to the one or more radios. The access point can be configured to establish a connection with one or more wireless devices through a wireless local area network (WLAN) over one or multiple wireless links. In some embodiments, the access point can operate in each of the multiple wireless links using a respective radio of the one or more radios.

For example, in some embodiments, a wireless device can operate in a lower capability mode of DPS operation and buffer data intended for a wireless station. Further, the wireless device can transition to a higher capability mode of DPS operation to participate in a transmit opportunity and transmit, during the transmit opportunity, the data to the wireless station. In addition, the wireless device can defer channel access for at least a first period of time upon completion of the transmit opportunity.

As another example, in some embodiments, a wireless device can reserve a transmit opportunity for transmitting data to an other wireless device operating in a lower capability mode of DPS operation. The reservation can indicate a network allocation vector (NAV) that includes a time period at an end of the transmit opportunity to allow the other wireless device to transition from a higher capability mode of DPS operation to a lower capability mode of DPS operation prior to the end of the transmit opportunity. Further, the wireless device can transmit, at the start of the transmit opportunity, an initial control frame to the wireless device and upon receiving an initial control response, transmit data to the wireless device.

As a further example, in some embodiments, a wireless device can receive, while operating in a lower capability mode of DPS operation, an initial control frame at a start of a transmit opportunity from a wireless station and transition to a higher capability mode of DPS operation to participate in the transmit opportunity. In addition, the wireless device can transmit, while in the higher capability mode of DPS operation, an initial control response (ICR) frame to the wireless station. and receive, from the wireless station, data during the transmission opportunity. The ICR frame can indicate whether or not a transition time deferral is required after the transmit opportunity.

As yet a further example, in some embodiments, a wireless device can broadcast a beacon frame that can indicate whether or not a transition time deferral is required after a transmit opportunity. The wireless device can receive, while operating in a lower capability mode of DPS operation, an initial control frame at a start of a transmit opportunity from a wireless station and transition to a higher capability mode of DPS operation to participate in the transmit opportunity. Further, the wireless device can transmit, while in the higher capability mode of DPS operation, an initial control response (ICR) frame to the wireless station and receive, from the wireless station, data during the transmission opportunity.

The techniques described herein can be implemented in and/or used with a number of different types of devices, including but not limited to cellular phones, tablet computers, accessory and/or wearable computing devices, portable media players, base stations, access points, and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments.

FIG. 2 is a block diagram illustrating an example wireless device, according to some embodiments.

FIG. 3 is a block diagram illustrating an example network element or access point, according to some embodiments.

FIG. 4 is a block diagram illustrating an example modem or baseband processor, according to some embodiments.

FIG. 5 illustrates an example timeline of access point mode switching during DPS operation.

FIGS. 6, 7, 8, 9, 10, 11A-11B, and 12A-12B illustrate examples of timelines for access point mode switching during DPS mode operation, according to some embodiments.

FIGS. 13, 14, 15, and 16 are flowchart diagrams illustrating methods for supporting dynamic power save (DPS) mode operation in a WLAN, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:

Memory Medium—Any of various types of non-transitory memory devices or storage devices. The term “memory medium” is intended to include any computer system memory or random access memory, such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), server-based computer system, wearable computer, network appliance, Internet appliance, smartphone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable, and that perform wireless communications. Examples of UE devices include mobile telephones or smart phones (e.g., iPhone™, Android™-based phones), tablet computers, portable gaming devices, laptops, wearable devices (e.g., smart watch, smart glasses, smart goggles, head-mounted display devices, and so forth), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device or Station (STA)—any of various types of computer systems or devices that perform wireless communications. A wireless device can be portable (or mobile) or can be stationary or fixed at a certain location. The terms “station” and “STA” are used similarly. A UE is an example of a wireless device.

Communication Device—any of various types of computer systems or devices that perform communications, where the communications can be wired or wireless. A communication device can be portable (or mobile) or can be stationary or fixed at a certain location. A wireless device is an example of a communication device. A UE is another example of a communication device.

Base Station or Access Point (AP)—The term “Base Station” has the full breadth of its ordinary meaning, and at least includes a wireless communication station installed at a fixed location and used to communicate as part of a wireless communication system. The term “access point” (or “AP”) is typically associated with Wi-Fi-based communications and is used similarly.

Processing Element (or Processor)—refers to various elements or combinations of elements that are capable of performing a function in a device, e.g., in a communication device or in a network infrastructure device. Processors can include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.

IEEE 802.11—refers to technology based on IEEE 802.11 wireless standards such as 802.11a, 802.11b, 802.11g, 802.11n, 802.11-2012, 802.11ac, 802.11ad, 802.11ax, 802.11ay, 802.11be, and/or other IEEE 802.11 standards. IEEE 802.11 technology can also be referred to as “Wi-Fi” or “wireless local area network (WLAN)” technology.

Configured to—Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

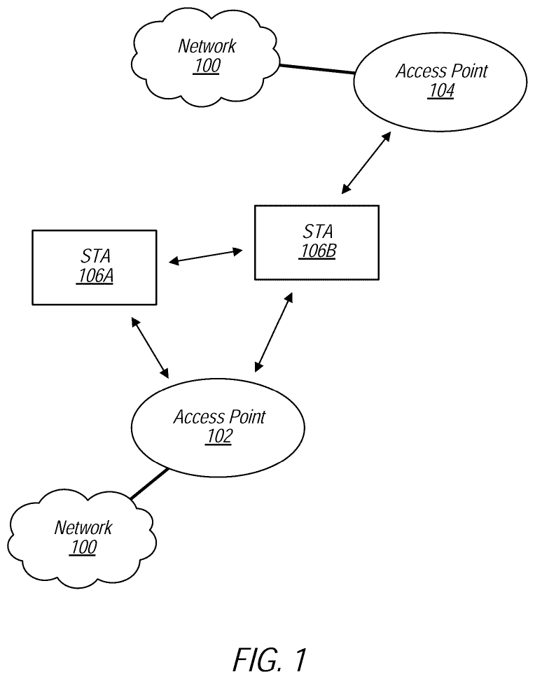

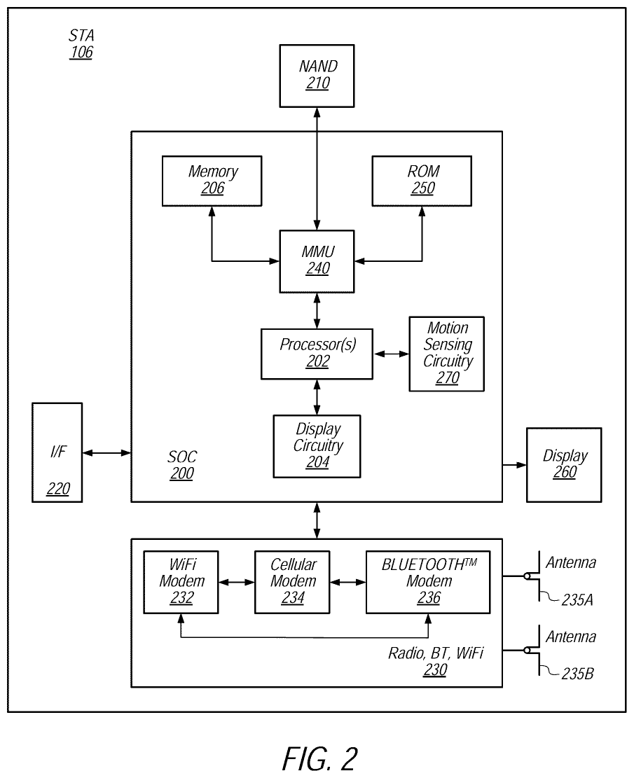

### FIGS. 1-2—Wireless Communication System

FIG. 1 illustrates an example of a wireless communication system. It is noted that FIG. 1 represents one possibility among many, and that features of the present disclosure can be implemented in any of various systems, as desired. For example, instances described herein can be implemented in any type of wireless device. The wireless communication system described below is one example.

As shown, the exemplary wireless communication system includes an access point (AP) 102, which communicates over a transmission medium with one or more wireless devices 106A, 106B, etc. Wireless devices 106A and 106B can be user devices, such as stations (STAs), non-AP STAs, UEs, or other WLAN devices.

The STA 106 can be a device with wireless network connectivity, such as a mobile phone, a hand-held device, a wearable device (e.g., such as a smart watch, smart glasses, and/or a head-mounted display device), a computer or a tablet, an unmanned aerial vehicle (UAV), an unmanned aerial controller (UAC), an automobile, or virtually any other type of wireless device. The STA 106 can include a processor (processing element) that is configured to execute program instructions stored in memory. The STA 106 can perform any of the methods described herein by executing one or more of such stored instructions. Alternatively, or in addition, the STA 106 can include a programmable hardware element, such as an FPGA (field-programmable gate array), an integrated circuit (e.g., an ASIC), a programmable logic device (PLD), and/or any of various other possible hardware components that are configured to perform (e.g., individually or in combination) any of the methods described herein, or any portion of any of the methods described herein.

The AP 102 can be a stand-alone AP or an enterprise AP, can be a base transceiver station (BTS) or cell site, and can include hardware that enables wireless communication with the STA devices 106A and 106B. The AP 102 can also be equipped to communicate with a network 100 (e.g., a core network of a service provider (e.g., a cellular service provider, an Internet service provider, and/or a carrier), a WLAN, an enterprise network, and/or another communication network connected to the Internet, among various possibilities). Thus, the AP 102 can facilitate communication among the STA devices 106 and/or between the STA devices 106 and the network 100. AP 102 can be configured to provide communications over one or more wireless technologies, such as any, any combination of, and/or all of 802.11 a, b, g, n, ac, ad, ax, ay, be and/or other 802.11 versions, and/or a cellular protocol, such as 6G, 5G and/or LTE, including in an unlicensed band.

The communication area (or coverage area) of the AP 102 can be referred to as a basic service area (BSA) or cell. The AP 102 and the STAs 106 can be configured to communicate over the transmission medium using any of various radio access technologies (RATs) or wireless communication technologies, such as Wi-Fi, LTE, LTE-Advanced (LTE-A), 5G NR, 6G, ultra-wideband (UWB), etc.

AP 102 and other similar access points (not shown) operating according to one or more wireless communication technologies can thus be provided as a network, which can provide continuous or nearly continuous overlapping service to STA devices 106A-B and similar devices over a geographic area, e.g., via one or more communication technologies. A STA can roam from one AP to another AP directly or can transition between APs and/or network cells (e.g., such as cellular network cells).

Note that at least in some instances a STA device 106 can be capable of communicating using any of multiple wireless communication technologies. For example, a STA device 106 might be configured to communicate using Wi-Fi, LTE, LTE-A, 5G NR, 6G, Bluetooth, UWB, one or more satellite systems, etc. Other combinations of wireless communication technologies (including more than two wireless communication technologies) are also possible. Likewise, in some instances a STA device 106 can be configured to communicate using only a single wireless communication technology.

As shown, the exemplary wireless communication system can also include an access point (AP) 104, which communicates over a transmission medium with the wireless device 106B. The AP 104 also provides communicative connectivity to the network 100. Thus, wireless devices can connect to either or both of AP 102 (or another cellular base station) and the access point 104 (or another access point) to access the network 100. For example, a STA can roam from AP 102 to AP 104, e.g., based on one or more factors, such as mobility, coverage, interference, and/or capabilities. Note that it can also be possible for the AP 104 to provide access to a different network (e.g., an enterprise Wi-Fi network, a home Wi-Fi network, etc.) than the network to which the AP 102 provides access.

The STAs 106A and 106B can include handheld devices such as smart phones or tablets, wearable devices such as smart watches, smart glasses, head-mountable display devices, and/or can include any of various types of devices with wireless communication capability. For example, one or more of the STAs 106A and/or 106B can be a wireless device intended for stationary or nomadic deployment, such as an appliance, measurement device/sensor, control device, etc.

The STA 106B can also be configured to communicate with the STA 106A. For example, the STA 106A and STA 106B can be capable of performing direct device-to-device (D2D) communication. Note that such direct communication between STAs can also or alternatively be referred to as peer-to-peer (P2P) communication. The direct communication can be supported by the AP 102 (e.g., the AP 102 can facilitate discovery, among various possible forms of assistance), or can be performed in a manner unsupported by the AP 102. Such P2P communication can be performed using 3GPP-based D2D communication techniques, Wi-Fi-based P2P communication techniques, UWB, BT, and/or any of various other direct communication techniques, according to various examples.

The STA 106 can include one or more devices or integrated circuits for facilitating wireless communication, potentially including a Wi-Fi modem, cellular modem, and/or one or more other wireless modems. The wireless modem(s) can include one or more processors (processor elements) and various hardware components as described herein. The STA 106 can perform any of (or any portion of) the methods described herein by executing instructions on one or more programmable processors. For example, the STA 106 can be configured to perform techniques according to the various methods described herein. Alternatively, or in addition, the one or more processors can be one or more programmable hardware elements such as an FPGA (field-programmable gate array), application-specific integrated circuit (ASIC), or other circuitry, that is configured to perform any of the methods described herein, or any portion of any of the methods described herein. The wireless modem(s) described herein can be used in a STA device as defined herein, a wireless device as defined herein, or a communication device as defined herein. The wireless modem described herein can also be used in an AP, a base station, a pico cell, a femto cell, and/or other similar network side device.

The STA 106 can include one or more antennas for communicating using two or more wireless communication protocols or radio access technologies (RATs). In some instances, the STA device 106 can be configured to communicate using a single shared radio. The shared radio can couple to a single antenna, or can couple to multiple antennas (e.g., for MIMO) for performing wireless communications. Alternatively, the STA device 106 can include two or more radios, each of which can be configured to communicate via a respective wireless link. Other configurations are also possible.

### FIG. 2—Example Block Diagram of a STA Device

FIG. 2 illustrates an example block diagram of a STA device, such as STA 106. In some instances, the STA 106 can additionally or alternatively be referred to as a UE 106. STA 106 also can be referred to as a non-AP STA 106. As shown, the STA 106 can include a system on chip (SOC) 200, which can include one or more portions configured for various purposes. Some or all of the various illustrated components (and/or other device components not illustrated, e.g., in variations and alternative arrangements) can be “communicatively coupled” or “operatively coupled,” which terms can be taken herein to mean components that can communicate, directly or indirectly, when the device is in operation.

In some instances, the STA 106 can be configured as a Multi-Link Device (MLD). In such instances, the STA 106 (e.g., one or more radios of the STA 106) can be configured for concurrent data transmission and reception in multiple channels across a single band and/or multiple frequency bands (e.g., such as a 2.4 GHz band, a 5 GHz band, and/or a 6 GHz band). As such, the STA 106 (e.g., one or more radios of the STA 106) can be configured to perform Multi-Link Operation (MLO). For example, the STA 106 (e.g., one or more radios of the STA 106) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

As shown, the SOC 200 can include processor(s) 202, which can execute program instructions for the STA 106, and display circuitry 204, which can perform graphics processing and provide display signals to the display 260. The SOC 200 can also include motion sensing circuitry 270, which can detect motion of the STA 106 in one or more dimensions, for example using a gyroscope, accelerometer, and/or any of various other motion sensing components. The processor(s) 202 can also be coupled to memory management unit (MMU) 240, which can be configured to receive addresses from the processor(s) 202 and translate those addresses to locations in memory (e.g., memory 206, read only memory (ROM) 250, flash memory 210). The MMU 240 can be configured to perform memory protection and page table translation or set up. In some instances, the MMU 240 can be included as a portion of the processor(s) 202.

As shown, the SOC 200 can be coupled to various other circuits of the STA 106. For example, the STA 106 can include various types of memory (e.g., including NAND flash 210), a connector interface 220 (e.g., for coupling to a computer system, dock, charging station, etc.), the display 260, and wireless communication circuitry 230 (e.g., for LTE, LTE-A, 5G NR, 6G, Bluetooth, Wi-Fi, NFC, GPS, UWB, peer-to-peer (P2P), device-to-device (D2D), etc.).

The STA 106 can include at least one antenna, and in some instances can include multiple antennas, e.g., 235A and 235B, for performing wireless communication with access points, base stations, wireless stations, and/or other devices. For example, the STA 106 can use antennas 235A and 235B to perform the wireless communication. As noted above, the STA 106 can, in some examples, be configured to communicate wirelessly using a plurality of wireless communication standards or radio access technologies (RATs).

The wireless communication circuitry 230 can include a Wi-Fi modem 232, a cellular modem 234, and a Bluetooth modem 236. Note that one or more of the Wi-Fi modem 232, the cellular modem 234, and/or the Bluetooth modem 236 can be configured for MLO, e.g., as described above. The Wi-Fi modem 232 is for enabling the STA 106 to perform Wi-Fi or other WLAN communications, e.g., on an 802.11 network. The Bluetooth modem 236 is for enabling the STA 106 to perform Bluetooth communications. The cellular modem 234 can be capable of performing cellular communication according to one or more cellular communication technologies, e.g., in accordance with one or more 3GPP specifications.

As described herein, STA 106 can include hardware and software components for implementing aspects of this disclosure. For example, one or more components of the wireless communication circuitry 230 (e.g., Wi-Fi modem 232, cellular modem 234, BT modem 236) of the STA 106 can be configured to implement part or all of the methods for an enhanced BSR in a wireless local area network system described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

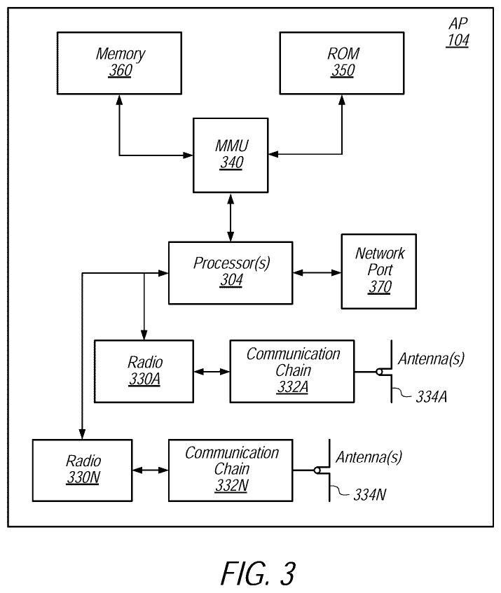

### FIG. 3—Block Diagram of an Access Point

FIG. 3 illustrates an example block diagram of an access point (AP) 104. In some instances (e.g., in an 802.11 communication context), the AP 104 can also be referred to as a station (STA), a mobile AP, and possibly more particularly as an AP STA. It is noted that the AP of FIG. 3 is merely one example of a possible access point. As shown, AP 104 can include processor(s) 304, which can execute program instructions for the AP 104. The processor(s) 304 can also be coupled to memory management unit (MMU) 340, which can be configured to receive addresses from the processor(s) 304 and translate those addresses to locations in memory (e.g., memory 360 and read only memory (ROM) 350) or to other circuits or devices.

In some instances, the AP 104 can be configured as a Multi-Link Device (MLD). In such instances, the AP 104 (e.g., one or more radios of the AP 104) can be configured for concurrent data transmission and reception in multiple channels across a single band and/or multiple frequency bands (e.g., such as a 2.4 GHz band, a 5 GHz band, and/or a 6 GHz band). As such, the AP 104 (e.g., one or more radios of the AP 104) can be configured to perform Multi-Link Operation (MLO). For example, the AP 104 (e.g., one or more radios of the AP 104) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The AP 104 can include at least one network port 370. The network port 370 can be configured to couple to a network and provide multiple devices, such as STA devices 106, with access to the network, for example as described herein above in FIG. 1.

The network port 370 (or an additional network port) can also or alternatively be configured to couple to a cellular network, e.g., a core network of a cellular service provider (e.g., a carrier and/or cellular carrier). The core network can provide mobility related services and/or other services to a plurality of devices, such as STA devices 106. In some cases, the network port 370 can couple to a telephone network via the core network, and/or the core network can provide a telephone network (e.g., among other STA devices serviced by the cellular service provider).

The AP 104 can include one or more radios 330A-330N, which can be coupled to one or more respective communication chains and at least one antenna 334, and possibly multiple antennas. The antenna(s) 334 can be configured to operate, in conjunction with one or more other components, as a wireless transceiver and can be further configured to communicate with STA devices 106 via radios 330A-330N. Note that one or more of the radios 330A-330N can be configured for MLO, e.g., as described above. The antenna(s) 334A-N communicate with one or more respective radios 330A-N via communication chains 332A-N. Communication chains 332 can be receive chains, transmit chains, or both. The radios 330A-N can be configured to communicate in accordance with various wireless communication standards, including, but not limited to, LTE, LTE-A, 5G NR, 6G, UWB, Wi-Fi, BT, etc. The AP 104 can be configured to operate on multiple wireless links using the one or more radios 330A-N. In some implementations, each radio can be used to operate on a respective wireless link.

The AP 104 can be configured to communicate wirelessly using multiple wireless communication standards. In some instances, the AP 104 can include multiple radios, which can enable the network entity to communicate according to multiple wireless communication technologies. For example, as one possibility, the AP 104 can include a 4G or 5G radio for performing communication according to a 3GPP wireless communication technology, as well as a Wi-Fi radio for performing communication according to one or more Wi-Fi specifications. In such a case, the AP 104 can be capable of operating as both a cellular base station and a Wi-Fi access point. As another possibility, the AP 104 can include a multi-mode radio that is capable of performing communications according to any of multiple wireless communication technologies (e.g., 5G NR and Wi-Fi, 5G NR and LTE, etc.). As still another possibility, the AP 104 can be configured to act exclusively as a Wi-Fi access point, e.g., without cellular communication capability.

As described further herein, the AP 104 can include hardware and software components for implementing or supporting implementation of features described herein, among various other possible features. The processor 304 of the AP 104 can be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, the processor 304 can be configured as a programmable hardware element, such as an FPGA (Field Programmable Gate Array) or ASIC (Application Specific Integrated Circuit), or a combination thereof. Alternatively (or in addition) the processor 304 of the AP 104, in conjunction with one or more of the other components 330, 332, 334, 340, 350, 360, 370 can be configured to implement, or support implementation of, part or all of the features described herein.

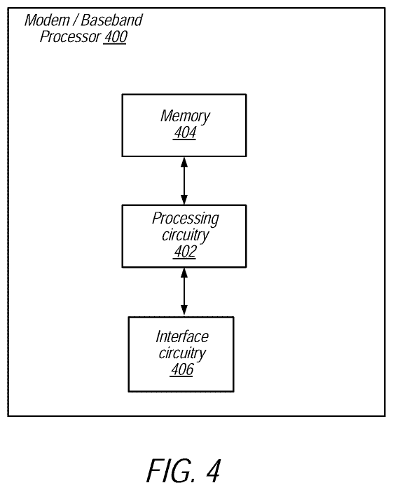

### FIG. 4—Block Diagram of a Modem or Baseband Processor

FIG. 4 illustrates an example block diagram of a modem 400, which can also be referred to as baseband processor 400. The modem 400 can provide signal processing functionality for one or more wireless communication technologies, such as Wi-Fi, Bluetooth, and/or a cellular (e.g., 3GPP) communication technology. Thus, as one possibility, modem 400 can represent a Wi-Fi modem; for example, the modem 400 illustrated in FIG. 4 can represent one possible example of Wi-Fi modem 232 illustrated in FIG. 2. As another possibility, modem 400 can represent a cellular modem or cellular baseband processor; for example, the modem 400 illustrated in FIG. 4 can represent one possible example of cellular modem 234 illustrated in FIG. 2. As a still further possibility, modem 400 can represent a Bluetooth modem; for example, the modem 400 illustrated in FIG. 4 can represent one possible example of Wi-Fi modem 236 illustrated in FIG. 2. As a yet further possibility, modem 400 can represent a radio; for example, the modem 400 illustrated in FIG. 4 can represent one possible example of radio 330A or radio 330N illustrated in FIG. 3. In some instances, the modem 400 could implement functionality for supporting communication according to multiple wireless communication technologies. At least in some instances, the modem 400 can run a real-time operating system, e.g., for facilitating performance of timing-dependent wireless communication functionality.

In some instances, the modem 400 can be configured for concurrent data transmission and reception in multiple channels across a single band and/or multiple frequency bands (e.g., such as a 2.4 GHz band, a 5 GHz band, and/or a 6 GHz band). As such, the modem 400 can be configured to perform Multi-Link Operation (MLO). For example, the modem 400 can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The modem 400 can include processing circuitry 402, which could include one or more processor cores, ASICs, programmable hardware elements, digital signal processors, and/or other processing elements. The processing circuitry can be capable of preparing baseband signals for up-conversion and transmission by radio circuitry of a wireless device, and/or for processing baseband signals received and down-converted by radio circuitry of a wireless device. Such processing could include signal modulation, encoding, decoding, etc., among various possible functions. The processing circuitry can also or alternatively be capable of performing functionality for one or more baseband and/or other layers/sublayers of a protocol stack for the wireless communication technology (or technologies) implemented by the modem 400, such as physical layer (PHY) functionality, media access control (MAC) functionality, logical link control (LLC) functionality, radio resource control (RRC) functionality, radio link control (RLC) functionality, etc. In some instances, the modem 400 can itself include at least some radio circuitry (e.g., for performing the conversion of input baseband signals to radio frequency signals and/or of input radio frequency signals to baseband signals). Alternatively, or in addition, some or all such functions can be performed by separate radio/transceiver components of the wireless device.

The modem 400 can also include memory 404, which can include a non-transitory computer-readable memory medium. The memory 404 can include program instructions for performing signal processing and/or any of various possible general processing functions. The processing circuitry 402 can be capable of executing the program instructions stored in the memory 404. The memory 404 can also store data generated and/or used during processing performed by the processing circuitry 402.

As shown, the modem 400 can further include interface circuitry, e.g., for communicating with other components of a wireless device (such as STA 106 or AP 104 illustrated in FIGS. 1-3), such as an application processor, radio/transceiver circuitry, and/or any of various other components. Such interfaces can be implemented in any of various ways; for example, as one possibility, the modem 400 can have a direct interface with transceiver circuitry of a wireless device and can have an additional indirect interface with an application processor and/or other components of the wireless device by way of a system bus. Other configurations are also possible.

In at least some instances, the hardware and software components of the modem 400 can be configured to implement or support implementation of features described herein, among various other possible features. For example, the processing circuitry 402 of the modem 400 can be configured to implement, or support implementation of, part or all of the methods described herein, e.g., by executing program instructions stored on memory (e.g., non-transitory computer-readable memory medium) 404 and/or using dedicated hardware components.

### AP Mode Switching in Dynamic Power Save Mode Operation

In current implementations, in a dynamic power save (DPS) mode of operation, a mobile access point (AP) can remain in a lower capability mode and listen for an initial control frame (ICF), e.g., from a wireless station, such as an ultra-high reliability (UHR) wireless station. The ICF can be a request-to-send (RTS) frame and/or a buffer status report poll (BSRP) trigger frame and can include padding to allow the mobile AP to transition from a lower capability (LC) mode of DPS operation to a higher capability (HC) mode of DPS operation. Then, upon reception of the ICF, e.g., from the wireless station, the mobile AP can transition to the higher capability mode of operation and remain in the higher capability mode of operation for a remaining duration of a transmit opportunity. At the end of the transmit opportunity, the mobile AP can then transition back to the lower capability mode of operation. Note that in the lower capability mode of operation, the mobile AP can listen to a medium using a lower bandwidth (e.g., as compared to the higher capability mode of operation) to conserve power.

In addition, for a dynamic power save (DPS) mode of operation, a mobile AP can announce its DPS capability. For example, an ICF Required field in an ICF frame can indicate whether a wireless station associated with the mobile AP requires an ICF and ICR exchange prior to any frame exchange initiated with the mobile AP operating in the DPS mode or only for the mobile AP to transition from the lower capability (LC) mode to the higher-capability (HC) mode. The ICF Required field can be set to a value of 1 to indicate that the ICF and ICR exchanges are required for all frame exchanges addressed to the mobile AP. The ICF Required field can be set to a value of 0 to indicate that the ICF and ICR exchanges are required only for frame exchanges addressed to the mobile AP that requires the mobile AP to transition from LC mode to the HC mode. Note that if a DPS Enabled field of the ICF frame is set to a value of 0, the ICF required field can be reserved.

Further, a mobile AP that has announced the ICF Required field set to a value of 1 in in an ultra-high reliability (UHR) Operation element of a beacon or probe response frame shall immediately transition to an HC mode after receiving an individually addressed probe request, authentication request, or association request frames from a wireless station not associated with the mobile AP, e.g., an unassociated STA. After transitioning to HC mode, the mobile AP should remain in HC mode until an association procedure is completed. Additionally, if the association is not successful, the mobile AP can transition to an LC mode.

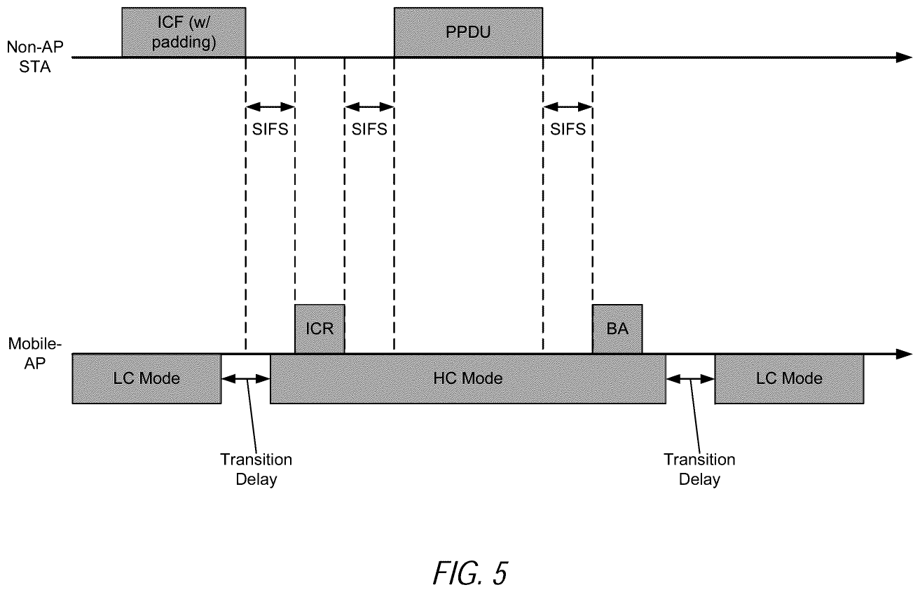

FIG. 5 illustrates an example timeline of AP mode switching during DPS operation. As shown, a wireless station, e.g. non-AP STA, can transmit an ICF to a mobile AP operating in a lower capability mode of DPS operation. Note that the ICF can be transmitted in a non-high throughput (HT) physical layer protocol data unit (PPDU) at a rate of 6 megabits per second (Mbps), 12 Mbps, or 24 Mbps. Upon receiving the ICF, the mobile AP can transition to a higher capability (HC) mode of operation. In addition, the mobile AP, after a SIFS, can respond with an initial control response (ICR) frame. Further, a SIFS after the ICR frame, the wireless station can transmit the data via an uplink (UL) PPDU. At the end of the UL PPDU, the mobile AP can send a block acknowledgement after waiting a SIFS. Further, after a transition delay interval, the mobile AP can transition back to the LC mode. Although the basic framework for mobile AP mode switching in DPS operation has been agreed upon, mobile AP/wireless station mode switching behavior, e.g., such as post transmit opportunity, has not been specified and/or defined. Therefore, improvements are desired.

Embodiments described herein provide method for mode switching behavior of an access point and/or wireless station in a dynamic power save (DPS) operation. In particular, embodiments described herein provide methods and mechanisms for transitions between higher capability mode and lower capability mode operation, including various methods for deferring channel access during a transition period of the mode switch. In addition, embodiments described herein define access point behavior during an association procedure.

As an example, in some embodiments, an access point (AP), e.g., a mobile AP, such as AP 104 and/or wireless station 106, operating in a lower capability mode of DPS operation, receives an authentication request frame from a wireless station, e.g., a non-AP STA, the access point can immediately (e.g., immediately upon reception and/or substantially immediately upon reception) can initiate processing of the authentication request, e.g., without sending an acknowledgement (ACK) control frame in response. In addition, the access point can transition to a higher capability mode of DPS operation. Further, instead of waiting for an authentication request frame to be retransmitted by the wireless station and the subsequent acknowledgment exchange, the access point can prioritize processing the authentication request and subsequently respond to the wireless station with an authentication response frame. Such a scheme can ensure that the authentication handshake progresses efficiently, thereby reducing latency and potential power consumption at the access point.

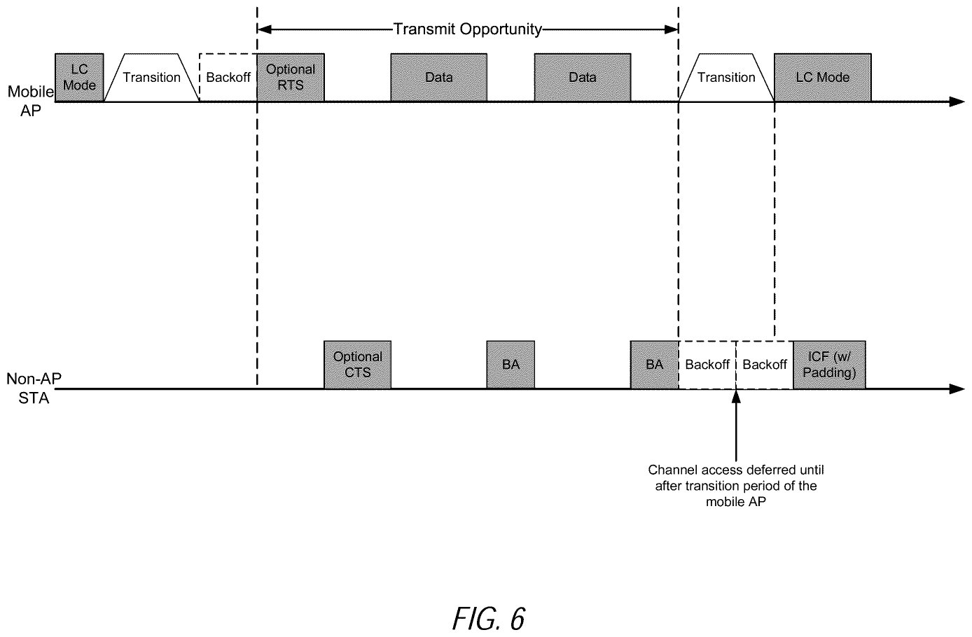

For example, FIGS. 6, 7, 8, 9, 10, 11A, 11B, 12A, and 12B illustrate examples of timelines for access point mode switching during DPS mode operation, according to some embodiments. Note that the illustrated timelines can be implemented in a wireless local area network (WLAN), e.g., such as an IEEE 802.11 based system, according to some embodiments. Note further that aspects of the illustrated timelines can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated elements and/or other elements. In addition, note that while at least some of the elements of illustrated timelines are described in a manner relating to the use of communication techniques and/or features associated with IEEE 802.11 specification documents, such description is not intended to be limiting to the disclosure, and aspects of the illustrated timelines can be used in any suitable wireless communication system, as desired.

FIG. 6 illustrates an example in which a mobile AP has data to transmit to a wireless station, according to some embodiments. As shown in FIG. 6, the timeline can begin when a mobile AP, such as AP 104 and/or wireless station 106, is operating in a lower capability mode of DPS operation. Upon receiving data intended for an associated wireless station (e.g., non-AP STA), e.g., a wireless station served by the mobile AP, such as a wireless station 106, the mobile AP can transition from the lower capability mode to a higher capability mode of DPS operation during a transition period. Then, after expiration of a backoff timer (e.g., “Backoff”), the mobile AP can enter a transmit opportunity. In some instances, the mobile AP can send a request-to-send (RTS) frame at the start of the transmit opportunity, although such an RTS frame may not be required, e.g., it can be considered optional. Further, when the mobile AP does send the RTS frame, the wireless station can then respond with a clear-to-send (CTS) frame. Again, such a frame may not be required, e.g., such as when the mobile AP does not send an RTS frame and, thus, can be considered optional. The mobile AP can then transmit data, e.g., via one or more physical protocol data units (PPDUs), to the wireless station, receiving a block acknowledgment from the wireless station after each data transmission. At the end of the transmit opportunity, the mobile AP can then transition back to the lower capability mode of DPS operation. Further, the wireless station can be required to wait until after the transition period before transmitting an ICF (e.g., with padding to allow the mobile AP to transition back to the higher capability mode of DPS operation) to the mobile AP, e.g., in instances in which the wireless station has data to transmit to the mobile AP. In other words, channel access of the wireless station can be deferred until after expiration of the transition period of the mobile AP. Note that such a deferral can be accomplished via one or more backoff timers. For example, the wireless station can set a single backoff timer that extends beyond the transition period of the mobile AP or use a shorter backoff timer that is reset one or multiple times such that a total backoff time extends beyond the transition period of the mobile AP.

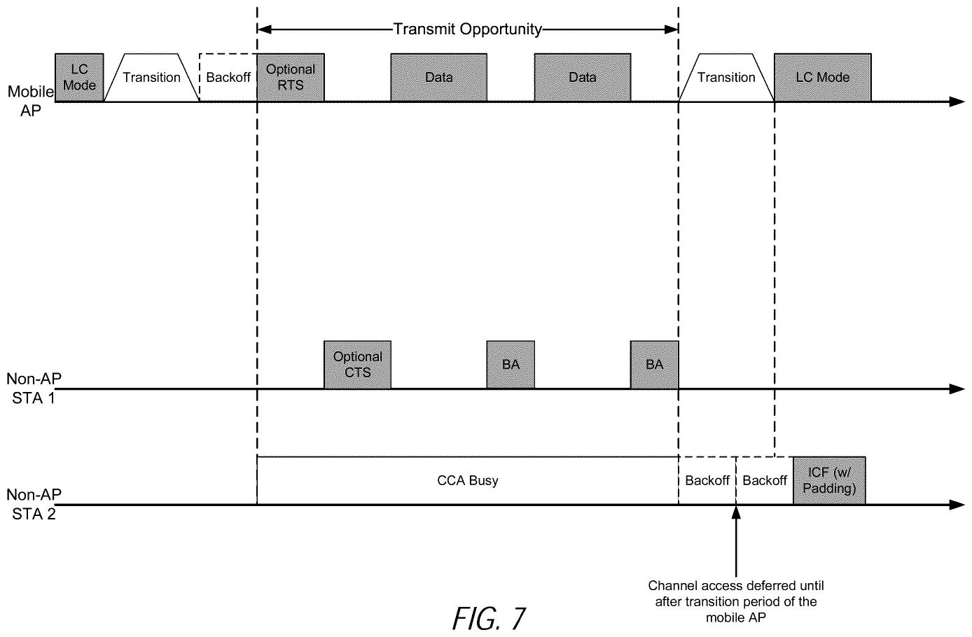

FIG. 7 illustrates an example in which a mobile AP has data to transmit to a first wireless station while a second wireless station waits to send data to the mobile AP, according to some embodiments. As shown in FIG. 7, the timeline can begin when a mobile AP, such as AP 104 and/or wireless station 106, is operating in a lower capability mode of DPS operation. Upon receiving data intended for an associated wireless station (e.g., non-AP STA 1), e.g., a wireless station served by the mobile AP, such as a wireless station 106, the mobile AP can transition from the lower capability mode to a higher capability mode of DPS operation during a transition period. Then, after expiration of a backoff timer (e.g., “Backoff”), the mobile AP can enter a transmit opportunity. In some instances, the mobile AP can send a request-to-send (RTS) frame to a first wireless station (e.g., non-AP STA 1) at the start of the transmit opportunity, although such an RTS frame may not be required, e.g., it can be considered optional. Further, when the mobile AP does send the RTS frame, the first wireless station can then respond with a clear-to-send (CTS) frame. Again, such a frame may not be required, e.g., such as when the mobile AP does not send an RTS frame and, thus, can be considered optional. The mobile AP can then transmit data, e.g., via one or more physical protocol data units (PPDUs), to the first wireless station, receiving a block acknowledgment from the first wireless station after each data transmission. At the end of the transmit opportunity, the mobile AP can then transition back to the lower capability mode of DPS operation. Further, during the transmit opportunity, a second wireless station associated with the mobile AP (e.g., non-AP STA 2) can determine that the medium is busy, e.g., via a clear channel access (CCA) procedure (e.g., CCA Busy). In other words, the second wireless station can detect that the mobile AP is either a transmit opportunity holder or transmit opportunity responder. In addition, when the second wireless station has data to transmit to the mobile AP, the second wireless station can be required to wait until after the transition period before transmitting an ICF (e.g., with padding to allow the mobile AP to transition back to the higher capability mode of DPS operation) to the mobile AP. In other words, channel access of the second wireless station can be deferred until after expiration of the transition period of the mobile AP. Note that such a deferral can be accomplished via one or more backoff timers. For example, the second wireless station can set a single backoff timer that extends beyond the transition period of the mobile AP or use a shorter backoff timer that is reset one or multiple times such that a total backoff time extends beyond the transition period of the mobile AP. In some instances, when the second wireless station detects a network allocation vector (NAV), e.g., based on the RTS/CTS exchange between the mobile AP and first wireless station, deferral of channel access can apply once the NAV has expired. In other instances, when the second wireless station does not set a NAV, deferral of channel access can apply when a physical CCA procedure indicates the medium is idle or detects an extended interframe space (EIFS).

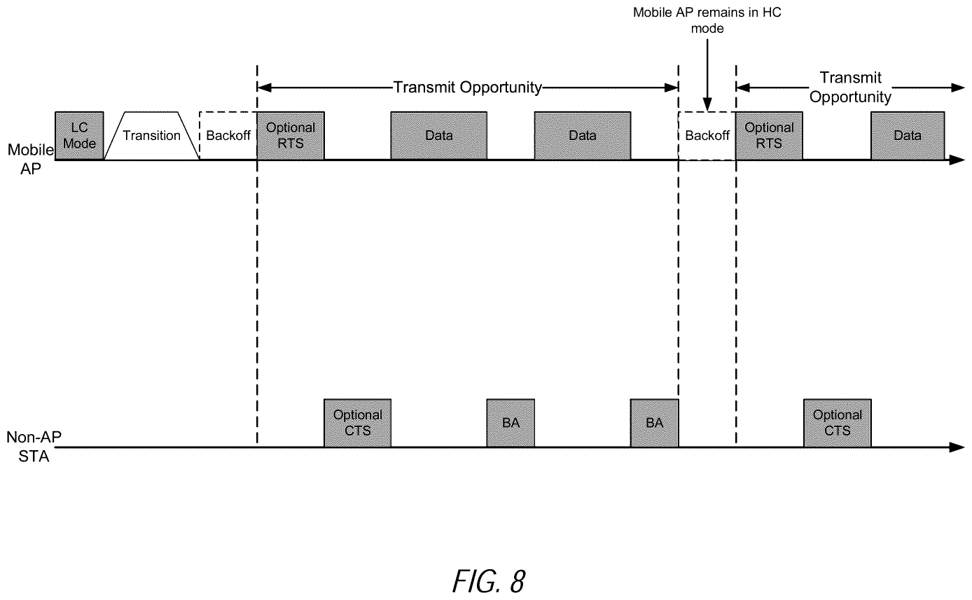

FIG. 8 illustrates an example in which a mobile AP has additional data to transmit to a wireless station after a transmit opportunity, according to some embodiments. As shown in FIG. 8, the timeline can begin when a mobile AP, such as AP 104 and/or wireless station 106, is operating in a lower capability mode of DPS operation. Upon receiving data intended for an associated wireless station (e.g., non-AP STA), e.g., a wireless station served by the mobile AP, such as a wireless station 106, the mobile AP can transition from the lower capability mode to a higher capability mode of DPS operation during a transition period. Then, after expiration of a backoff timer (e.g., “Backoff”), the mobile AP can enter a transmit opportunity. In some instances, the mobile AP can send a request-to-send (RTS) frame at the start of the transmit opportunity, although such an RTS frame may not be required, e.g., it can be considered optional. Further, when the mobile AP does send the RTS frame, the wireless station can then respond with a clear-to-send (CTS) frame. Again, such a frame may not be required, e.g., such as when the mobile AP does not send an RTS frame and, thus, can be considered optional. The mobile AP can then transmit data, e.g., via one or more physical protocol data units (PPDUs), to the wireless station, receiving a block acknowledgment from the wireless station after each data transmission. At the end of the transmit opportunity, when the mobile AP has additional data to transmit to the wireless station, the mobile AP can remain in the higher capability mode of DPS operation. In such instances, the mobile AP can be required to wait a period of time, e.g., via setting a backoff timer, prior to entering a new transmit opportunity. Upon expiration of the backoff timer, the mobile AP can then enter the new transmit opportunity either by initiating an RTS/CTS exchange with the wireless station or by immediately transmitting the additional data to the wireless station. In other words, although the mobile AP can remain in the higher capability mode of DPS operation, the mobile AP can still be required to defer channel access for at least the period of time corresponding to the backoff timer.

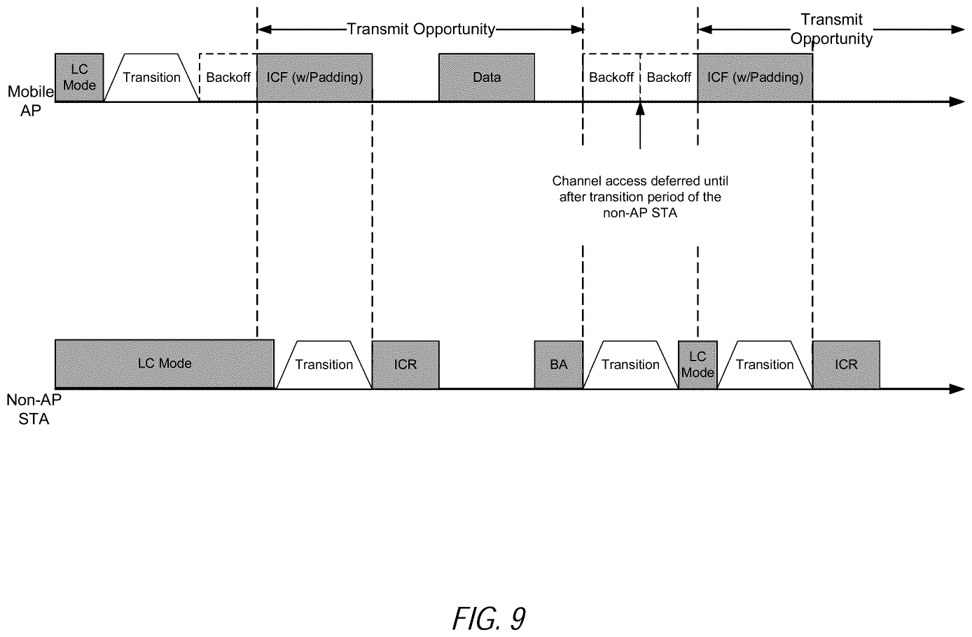

FIG. 9 illustrates an example in which a mobile AP has additional data to transmit to a wireless station also operating in DPS mode after a transmit opportunity, according to some embodiments. As shown in FIG. 9, the timeline can begin when a mobile AP, such as AP 104 and/or wireless station 106, is operating in a lower capability mode of DPS operation. Upon receiving data intended for an associated wireless station (e.g., non-AP STA), e.g., a wireless station served by the mobile AP, such as a wireless station 106, the mobile AP can transition from the lower capability mode to a higher capability mode of DPS operation during a transition period. Then, after expiration of a backoff timer (e.g., “Backoff”), the mobile AP can enter a transmit opportunity. Since the wireless station can also be operating in a lower capability mode of DPS operation, the mobile AP can transmit an ICF with padding to trigger the wireless station to transition to a higher capability mode of DPS operation and allow time for the transition. Further, upon receiving an ICR from the wireless station, the mobile AP can then transmit data, e.g., via one or more physical protocol data units (PPDUs), to the wireless station, receiving a block acknowledgment from the wireless station after each data transmission. At the end of the transmit opportunity, when the mobile AP has additional data to transmit to the wireless station, the mobile AP can remain in the higher capability mode of DPS operation. However, the wireless station can transition back to a lower capability mode of DPS operation over a transition period. Further, the mobile AP can be required to wait until after the transition period before transmitting an ICF (e.g., with padding to allow the wireless station to transition back to the higher capability mode of DPS operation) to the wireless station. In other words, channel access of the mobile AP can be deferred until after expiration of the transition period of the wireless station. Note that such a deferral can be accomplished via one or more backoff timers. For example, the mobile AP can set a single backoff timer that extends beyond the transition period of the wireless station or use a shorter backoff timer that is reset one or multiple times such that a total backoff time extends beyond the transition period of the wireless station.

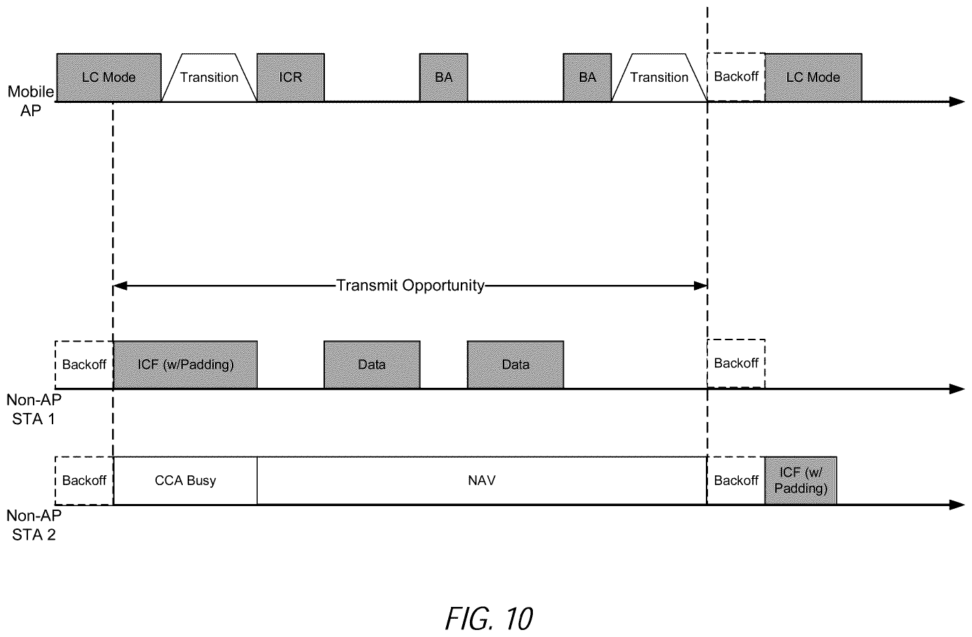

FIG. 10 illustrates an example in which a multiple wireless stations have data to transmit to a mobile AP, according to some embodiments. As shown in FIG. 10, the timeline can begin when a mobile AP, such as AP 104 and/or wireless station 106, is operating in a lower capability mode of DPS operation. As shown, after completion of a backoff timer, a first wireless station (e.g., non-AP STA 1), such as a wireless station 106, associated with the mobile AP can enter a transmit opportunity and transmit an ICF with padding to the mobile AP. A second wireless station (e.g., non-AP STA 2) can sense the ICF and determine that the medium is busy (e.g., CCA busy). Note that the first wireless station can also indicate a NAV to allow the second wireless station and mobile AP to determine a duration of the transmit opportunity. In some instances, the NAV can include a transition time interval to allow the mobile AP to transition back to the lower capability mode of operation prior to an end of the transmit opportunity. Upon receiving the ICF, the mobile AP can transition to a higher capability mode of DPS operation and transmit an ICR frame to the first wireless station. The first wireless station can then transmit data, e.g., via one or more physical protocol data units (PPDUs), to the mobile AP, receiving a block acknowledgment from the mobile AP after each data transmission. After transmitting a final block acknowledgement, the mobile AP can transition back into the lower capability mode of operation, e.g., prior to an end of the transmit opportunity. Further, although the second wireless station has data to transmit to the mobile AP, the second wireless station can be required to wait until a backoff time period prior to accessing the medium. In other words, channel access of the second wireless station can be deferred for at least the backoff time period. Note that such a deferral can be accomplished via one or more backoff timers. For example, the second wireless station can set a single backoff timer or use a shorter backoff timer that is reset one or multiple times such that the backoff time is achieved. Upon completion of the backoff time period, the second wireless station can then access the medium and transmit an ICF with padding to the mobile AP.

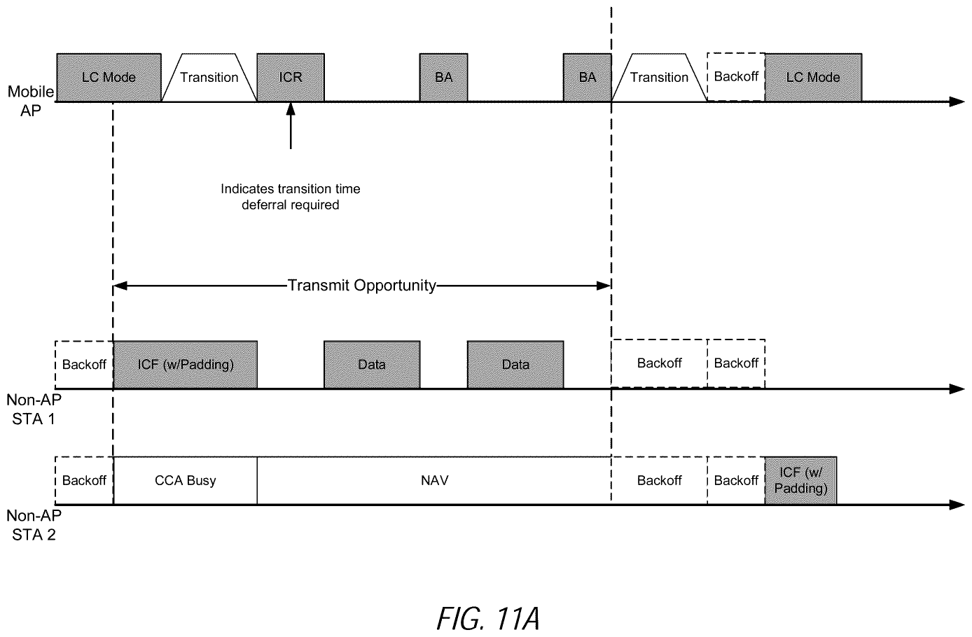

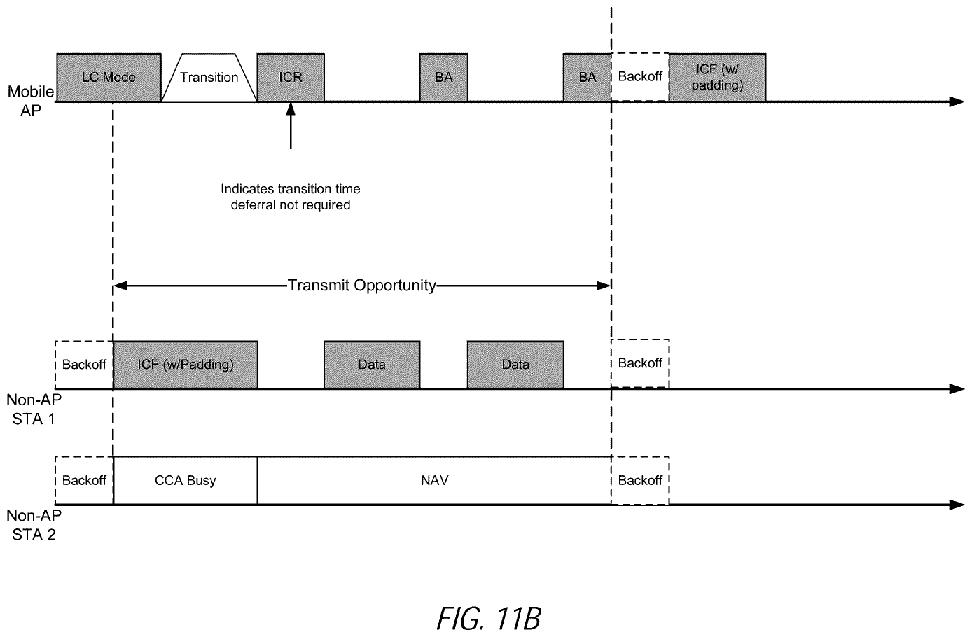

FIGS. 11A and 11B illustrate additional examples in which a multiple wireless stations have data to transmit to a mobile AP, according to some embodiments. As shown in FIGS. 11A and 11B, the timeline can begin when a mobile AP, such as AP 104 and/or wireless station 106, is operating in a lower capability mode of DPS operation. As shown, after completion of a backoff timer, a first wireless station (e.g., non-AP STA 1), such as a wireless station 106, associated with the mobile AP can enter a transmit opportunity and transmit an ICF with padding to the mobile AP. A second wireless station (e.g., non-AP STA 2) can sense the ICF and determine that the medium is busy (e.g., CCA busy). Note that the first wireless station can also indicate a NAV to allow the second wireless station and mobile AP to determine a duration of the transmit opportunity. Upon receiving the ICF, the mobile AP can transition to a higher capability mode of DPS operation and transmit an ICR frame to the first wireless station. The ICR frame can indicate whether or not the mobile AP requires a transition delay after the transmit opportunity. The first wireless station can then transmit data, e.g., via one or more physical protocol data units (PPDUs), to the mobile AP, receiving a block acknowledgment from the mobile AP after each data transmission.

In some instances, for example as shown in FIG. 11A, the mobile AP can indicate that a transition time is required in the ICR. Thus, at the end of the transmit opportunity, the mobile AP can transition back into the lower capability mode of operation. Further, although the second wireless station has data to transmit to the mobile AP, the second wireless station can be required to wait until after the transition period before transmitting an ICF (e.g., with padding to allow the mobile AP to transition back to the higher capability mode of DPS operation) to the mobile AP. In other words, channel access of the second wireless station can be deferred until after expiration of the transition period of the mobile AP. Note that such a deferral can be accomplished via one or more backoff timers. For example, the second wireless station can set a single backoff timer that extends beyond the transition period of the mobile AP or use a shorter backoff timer that is reset one or multiple times such that a total backoff time extends beyond the transition period of the mobile AP.

In some instances, for example, as shown in FIG. 11B, the mobile AP can indicate that a transition time is not required in the ICR. Thus, at the end of the transmit opportunity, the mobile AP can remain in the higher capability mode of DPS operation. In such instances, the second wireless station can be required to wait a period of time, e.g., via setting a backoff timer, prior to transmitting an ICF to the mobile AP. In other words, although the mobile AP remains in the higher capability mode of DPS operation, the second wireless station can still be required to defer channel access for at least the period of time corresponding to the backoff timer.

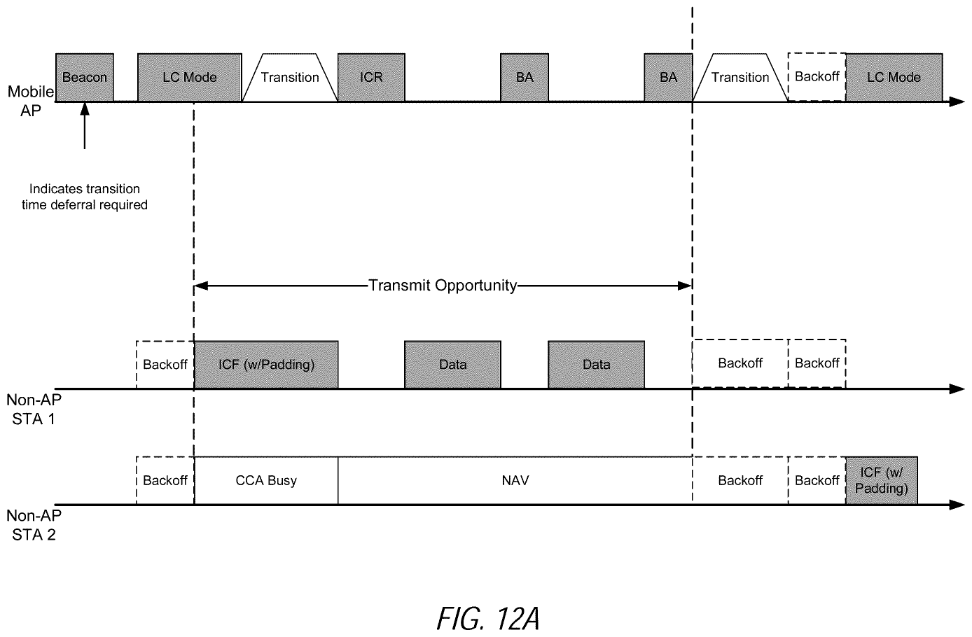

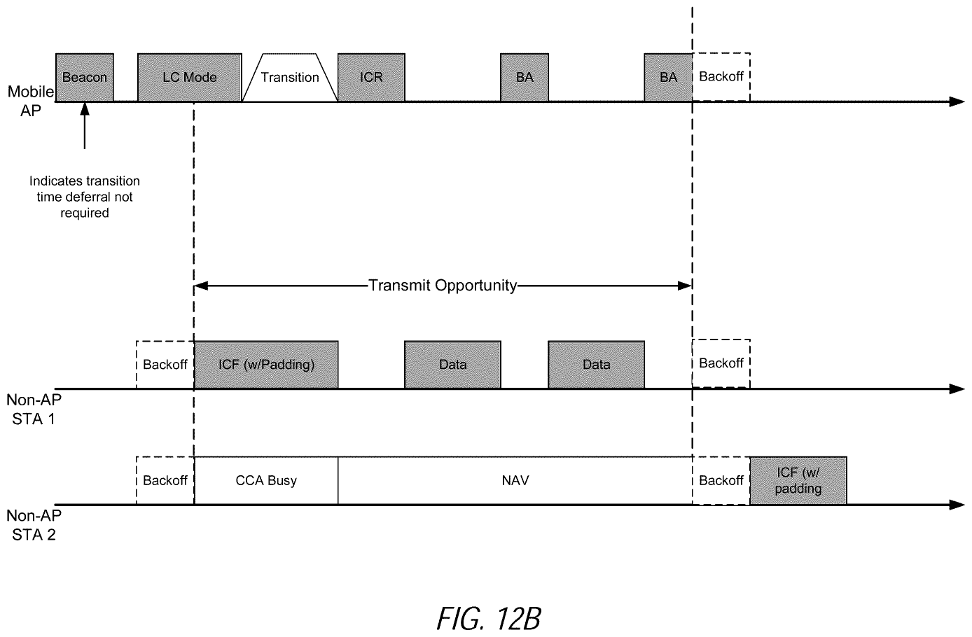

FIGS. 12A and 12B illustrate additional examples in which a multiple wireless stations have data to transmit to a mobile AP, according to some embodiments. As shown in FIGS. 12A and 12B, the timeline can begin with a mobile AP, such as AP 104 and/or wireless station 106, transmitting a beacon frame indicating whether or not the mobile AP requires a transition delay after the transmit opportunity. At a later time, the timeline can continue when the mobile AP is operating in a lower capability mode of DPS operation. As shown, after completion of a backoff timer, a first wireless station (e.g., non-AP STA 1), such as a wireless station 106, associated with the mobile AP can enter a transmit opportunity and transmit an ICF with padding to the mobile AP. A second wireless station (e.g., non-AP STA 2) can sense the ICF and determine that the medium is busy (e.g., CCA busy). Note that the first wireless station can also indicate a NAV to allow the second wireless station and mobile AP to determine a duration of the transmit opportunity. Upon receiving the ICF, the mobile AP can transition to a higher capability mode of DPS operation and transmit an ICR frame to the first wireless station. The first wireless station can then transmit data, e.g., via one or more physical protocol data units (PPDUs), to the mobile AP, receiving a block acknowledgment from the mobile AP after each data transmission.

In some instances, for example as shown in FIG. 12A, the mobile AP can indicate that a transition time is required in the beacon frame. Thus, at the end of the transmit opportunity, the mobile AP can transition back into the lower capability mode of operation. Further, although the second wireless station has data to transmit to the mobile AP, the second wireless station can be required to wait until after the transition period before transmitting an ICF (e.g., with padding to allow the mobile AP to transition back to the higher capability mode of DPS operation) to the mobile AP. In other words, channel access of the second wireless station can be deferred until after expiration of the transition period of the mobile AP. Note that such a deferral can be accomplished via one or more backoff timers. For example, the second wireless station can set a single backoff timer that extends beyond the transition period of the mobile AP or use a shorter backoff timer that is reset one or multiple times such that a total backoff time extends beyond the transition period of the mobile AP.

In some instances, for example, as shown in FIG. 12B, the mobile AP can indicate that a transition time is not required in the beacon frame. Thus, at the end of the transmit opportunity, the mobile AP can remain in the higher capability mode of DPS operation. In such instances, the second wireless station can be required to wait a period of time, e.g., via setting a backoff timer, prior to transmitting an ICF to the mobile AP. In other words, although the mobile AP remains in the higher capability mode of DPS operation, the second wireless station can still be required to defer channel access for at least the period of time corresponding to the backoff timer.

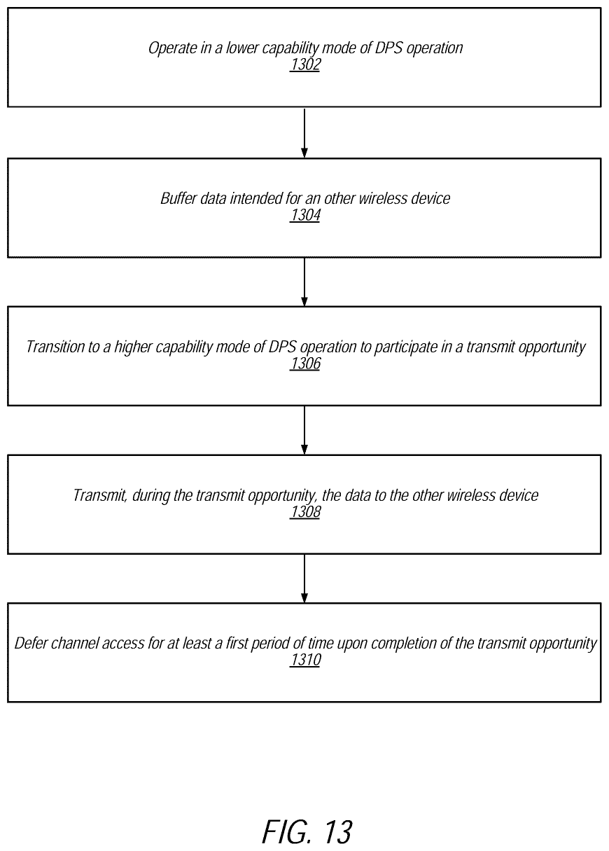

FIGS. 13, 14, 15, and 16 are flowchart diagrams illustrating methods for supporting dynamic power save (DPS) mode operation in a WLAN, according to some embodiments. In various embodiments, one or more of the elements of the methods shown can be performed concurrently, in a different order than shown, can be substituted for by one or more other method elements, or can be omitted. Additional method elements can also be performed as desired.

Aspects of the methods of FIGS. 13, 14, 15, and 16 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated method elements and/or other method elements.

Note that while at least some elements of the methods of FIGS. 13, 14, 15, and 16 are described in a manner relating to the use of communication techniques and/or features associated with IEEE 802.11 specification documents, such description is not intended to be limiting to the disclosure, and aspects of the methods of FIGS. 13, 14, 15, and 16 can be used in any suitable wireless communication system, as desired. Turning to FIG. 13, as shown, the method can operate as follows.

At 1302, a wireless device can operate in a lower capability mode of DPS operation.

At 1304, the wireless device can buffer data intended for an other wireless device.

At 1306, the wireless device can transition to a higher capability mode of DPS operation to participate in a transmit opportunity.

At 1308, the wireless device can transmit, during the transmit opportunity, the data to the other wireless device.

At 1310, the wireless device can defer channel access for at least a first period of time upon completion of the transmit opportunity. The first period of time can include at least a transition delay associated with transitioning from the higher capability mode of operation to the lower capability mode of operation. In some instances, the first period of time can include at least a channel access backoff time period. In some instances, the first period of time can include at least a transition delay associated with the wireless station transitioning from the higher capability mode of operation to the lower capability mode of operation.

In some instances, the wireless device can transition, during the first period of time, to the lower capability mode of DPS operation. Further, the wireless device can receive, after the first time period, an initial control frame (ICF) from the other wireless device while operating in the lower capability mode of DPS operation and transition back to the higher capability mode of operation.

In some instances, the wireless device can enter, after the first period of time and while remaining in the higher capability mode of DPS operation, a new transmit opportunity and transmit, to the other wireless device, additional data.

In some instances, the wireless device can enter, after the first period of time and while remaining in the higher capability mode of DPS operation, a new transmit opportunity and transmit, to the other wireless device, an initial control frame (ICF).

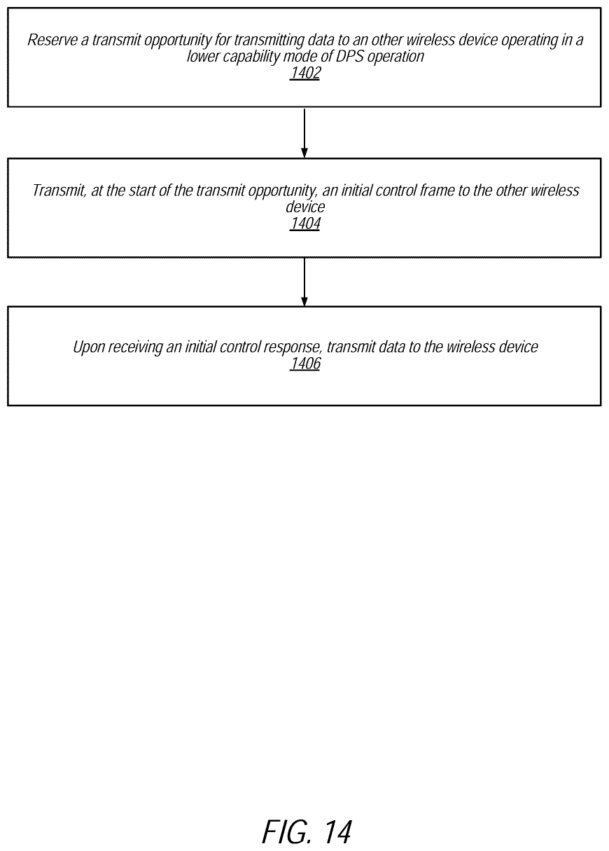

Turning to FIG. 14, as shown, the method can operate as follows.

At 1402, a wireless device can reserve a transmit opportunity for transmitting data to an other wireless device operating in a lower capability mode of DPS operation. The reservation can indicate a network allocation vector (NAV) that includes a time period at an end of the transmit opportunity to allow the other wireless device to transition from a higher capability mode of DPS operation to a lower capability mode of DPS operation prior to the end of the transmit opportunity.

At 1404, the wireless device can transmit, at the start of the transmit opportunity, an initial control frame to the other wireless device. In some instances, the initial control frame can include padding to allow the other wireless device to transition from the lower capability mode of DPS operation to the higher capability mode of DPS operation.

At 1406, the wireless device can, upon receiving an initial control response, transmit data to the wireless device.

In some instances, the wireless device can receive, from the other wireless device, a block acknowledgement.

In some instances, the wireless device can defer channel access for the time period at the end of the transmit opportunity.

In some instances, the wireless device can defer channel access after completion of the transmit opportunity for at least a second time period. The second period of time can include at least a channel access backoff time period.

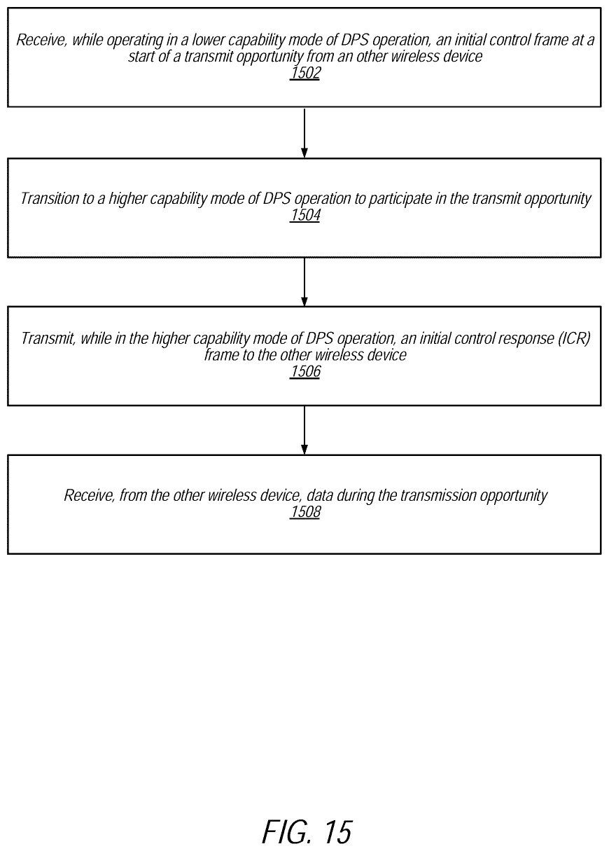

Turning to FIG. 15, as shown, the method can operate as follows.

At 1502, a wireless device can receive, while operating in a lower capability mode of DPS operation, an initial control frame at a start of a transmit opportunity from an other wireless device.

At 1504, the wireless device can transition to a higher capability mode of DPS operation to participate in the transmit opportunity.

At 1506, the wireless device can transmit, while in the higher capability mode of DPS operation, an initial control response (ICR) frame to the other wireless device. The ICR frame can indicate whether or not a transition time deferral is required after the transmit opportunity.

In some instances, when the ICR frame indicates the transition time deferral is required, the wireless device can transition, during the transition time deferral, to the lower capability mode of DPS operation. In addition, the wireless device can receive, after a second period of time, an other initial control frame from the other wireless device or an additional wireless device and transition back to the higher capability mode of DPS operation. The second period of time can include at least a channel access backoff time period.

In some instances, when the ICR frame indicates the transition time deferral is not required, the wireless device can remain in the higher capability mode of DPS operation and transmit, after a second period of time, an initial control frame to the wireless station or another wireless station. The second period of time can include at least a channel access backoff time period.

At 1508, the wireless device can receive, from the other wireless device, data during the transmission opportunity.

In some instances, the wireless device can transmit, to the other wireless device, a block acknowledgement.

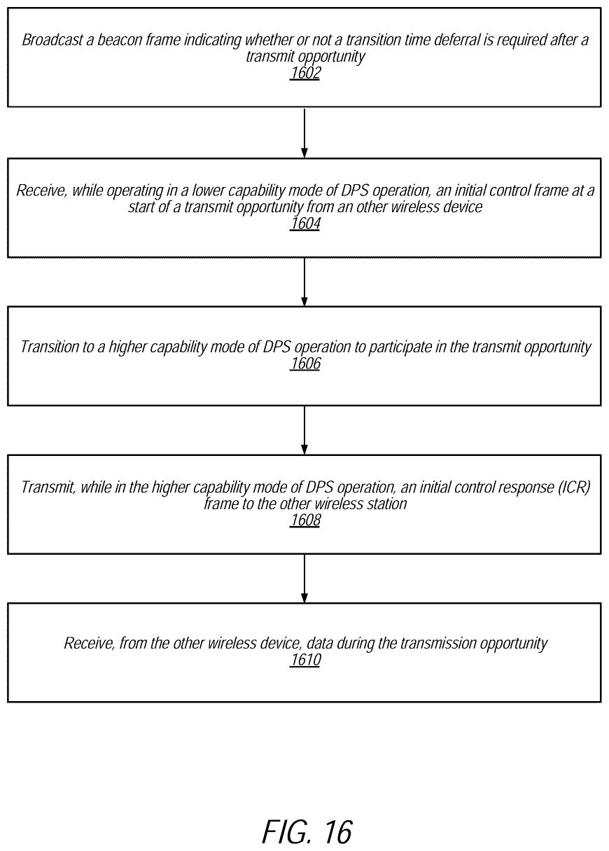

Turning to FIG. 16, as shown, the method can operate as follows.

At 1602, a wireless device can broadcast a beacon frame indicating whether or not a transition time deferral is required after a transmit opportunity.

In some instances, when the beacon frame indicates the transition time deferral is required, the wireless device can transition, during the transition time deferral, to the lower capability mode of DPS operation. The wireless device can receive, after a second period of time, an other initial control frame from the other wireless device or an additional wireless device and transition back to the higher capability mode of DPS operation. The second period of time can include at least a channel access backoff time period.

In some instances, when the beacon frame indicates the transition time deferral is not required, the wireless device can remain in the higher capability mode of DPS operation and transmit, after a second period of time, an initial control frame to the other wireless device or an additional wireless device. The second period of time can include at least a channel access backoff time period.

At 1604, the wireless device can receive, while operating in a lower capability mode of DPS operation, an initial control frame at a start of a transmit opportunity from an other wireless device.

At 1606, the wireless device can transition to a higher capability mode of DPS operation to participate in the transmit opportunity.

At 1608, the wireless device can transmit, while in the higher capability mode of DPS operation, an initial control response (ICR) frame to the other wireless station.

At 1610, the wireless device can receive, from the other wireless device, data during the transmission opportunity.

In some instances, the wireless device can transmit, to the other wireless device, a block acknowledgement.

Thus, according to the methods of FIGS. 13, 14, 15, and 16, it can be possible to support DPS mode operation in a WLAN setting, for example to provide better handling for low latency traffic and/or co-existence events, among various possibilities. Such techniques can provide improved latency for targeted traffic types, reduced need for error handling, reduced coexistence interference caused, and/or provide any of a variety of other possible benefits, at least according to some embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a STA 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for dynamic power save (DPS) mode operation performed by a mobile access point (AP), the method comprising:
receiving, while operating in a lower capability (LC) mode of DPS operation, an initial control frame (ICF) from a wireless station at a start of a transmit opportunity;
transitioning, in response to receiving the ICF, from the LC mode to a higher capability (HC) mode of DPS operation;
transmitting, while operating in the HC mode, an initial control response (ICR) frame to the wireless station during the transmit opportunity;
transitioning, during a transition delay associated with switching from the HC mode to the LC mode, from the HC mode to the LC mode; and
deferring channel access during the transition delay.

2. The method of claim 1,
wherein a reserved time period corresponding to the transmit opportunity includes the transition delay.

3. The method of claim 2, wherein the reserved time period further includes a delay associated with transitioning from the LC mode to the HC mode prior to transmission of the ICR frame.

4. The method of claim 1,
wherein a duration value in the ICF is configured to include at least the transition delay.

5. The method of claim 4,
wherein the duration value in the ICF includes both a data transmission duration and the transition delay.

6. The method of claim 1,
wherein the ICF includes padding configured to provide time for transitioning from the LC mode to the HC mode prior to exchanging data with the wireless station.

7. The method of claim 1,
wherein the transition delay is based on at least one of:
a channel bandwidth difference between the HC mode and the LC mode;
a spatial stream difference between the HC mode and the LC mode; or
a transmission power difference between the HC mode and the LC mode.

8. The method of claim 1,
wherein transitioning from the LC mode to the HC mode comprises increasing at least one of channel bandwidth, a number of spatial streams, or transmission power of the mobile AP.

9. The method of claim 1,
wherein operating in the LC mode comprises listening using reduced capability parameters relative to the HC mode.

10. The method of claim 9,
wherein the reduced capability parameters include at least one of reduced channel bandwidth, a reduced number of spatial streams, or a reduced transmission power relative to the HC mode.

11. The method of claim 1,
wherein deferring channel access comprises refraining from initiating a subsequent transmit opportunity until completion of the transition delay.

12. The method of claim 1, further comprising:
receiving, while operating in the LC mode after completion of the transition delay, another ICF from the wireless station before transitioning to the HC mode for a subsequent transmit opportunity.

13. A wireless device, comprising:
one or more antennas;
one or more radios operably coupled to the one or more antennas; and
a baseband processor operably coupled to the one or more radios;
wherein the baseband processor is configured to cause the wireless device to perform operations comprising:
receiving, while operating in a lower capability (LC) mode of DPS operation, an initial control frame (ICF) from a wireless station at a start of a transmit opportunity;
transitioning, in response to receiving the ICF, from the LC mode to a higher capability (HC) mode of DPS operation;
transmitting, while operating in the HC mode, an initial control response (ICR) frame to the wireless station during the transmit opportunity;
transitioning, during a transition delay associated with switching from the HC mode to the LC mode, from the HC mode to the LC mode; and
deferring channel access during the transition delay.

14. The wireless device of claim 13,
wherein the ICR frame indicates whether the transition delay is to be applied after the transmit opportunity.

15. The wireless device of claim 13,
wherein the transition delay corresponds to a padding delay indicated by the mobile AP in a dynamic power save (DPS) operation parameter field.

16. The wireless device of claim 13,
wherein the ICF comprises a request-to-send (RTS) frame or a buffer status report poll (BSRP) frame.

17. The wireless device of claim 13,
wherein to perform transmitting the ICR frame, the baseband processor is further configured to cause the wireless device to perform operations comprising transmitting the ICR frame before exchanging data with the wireless station during the transmit opportunity.

18. A non-transitory computer readable memory medium storing program instructions executable by processing circuitry to cause a wireless device to perform operations comprising:
receiving, while operating in a lower capability (LC) mode of DPS operation, an initial control frame (ICF) from a wireless station at a start of a transmit opportunity;
transitioning, in response to receiving the ICF, from the LC mode to a higher capability (HC) mode of DPS operation;
transmitting, while operating in the HC mode, an initial control response (ICR) frame to the wireless station during the transmit opportunity;
transitioning, during a transition delay associated with switching from the HC mode to the LC mode, from the HC mode to the LC mode; and
deferring channel access during the transition delay.

19. The non-transitory computer readable memory medium of claim 18,
wherein the program instructions are further executable by the processing circuitry to cause the wireless device to perform operations comprising:
initiating, upon receipt of the ICF, the transmit opportunity while operating in the LC mode.

20. The non-transitory computer readable memory medium of claim 18,
wherein the program instructions are further executable by the processing circuitry to cause the wireless device to perform operations comprising:
transmitting a block acknowledgement during the transmit opportunity.
